(19) United States
(12) Patent Application Publication
(10) Pub. No.: US 2007/0088580 A1
(43) Pub. Date: Apr. 19, 2007

(54) Systems and methods for providing comparative health care information via a network

(76) Inventor: John William Richards JR., Evans, GA (US)

Correspondence Address: Christopher J. Chan;SUTHERLAND ASBILL & BRENNAN LLP, 999 Peachtree Street, NE, Atlanta, GA, 30309-3996, US

(21) Appl. No.: 11/504,464

(22) Filed: Aug. 15, 2006

Related U.S. Application Data
(60) Provisional application No. 60/728,102, filed on Oct. 19, 2005.

(51) Int. Cl. G06Q 40/00

(52) U.S. Cl. 705/4

(57) ABSTRACT

The invention relates to methods and systems for providing comparative health care information via a network. One embodiment of the invention can comprise a comparative information application engine. The comparative information application engine can be adapted to receive claim-related information. Claim-related information can be stored in a database or other data storage device. Cost information can be determined from at least a portion of the claim-related information. Provider information can be determined from at least a portion of the claim-related information. In this embodiment, the claim-related information can be processed by an automated disclosure processing application program. In response to the request for statistical information, an output can be generated based at least in part on the provider information or the cost information.

### RELATED APPLICATIONS

This application claims priority to U.S. Provisional Ser. No. 60/728,102, entitled “SYSTEMS AND METHODS FOR PROVIDING COMPARATIVE HEALTH CARE INFORMATION VIA A NETWORK,” filed Oct. 19, 2005, the contents of which are hereby incorporated by reference.

### FIELD OF THE INVENTION

The invention is generally directed to systems and methods for providing health care information. More particularly, the invention relates to systems and methods for providing comparative health care information via a network.

### BACKGROUND

Consumers are often faced with decisions about what type of medical care to seek, which service providers to obtain medical care from, how much medical care or a particular procedure may cost, and the quality of medical care or procedures provided by a particular medical care provider. In many instances, a consumer may know he or she needs a particular medical care specialist, but may not have any information about the particular specialist except for a referral from friends, family, or his or her own physician or primary care physician. Such referrals, and the consumer decision to seek the particular referral, may be based on unreliable or suspect information since referrals are often made by word of mouth, anecdotal information, or a pre-existing relationship. Likewise, a consumer may have been recommended to undergo a test or procedure, or may have had a particular medical care provider recommended, but the consumer may not have any information for comparing the quality and/or cost of a test or procedure performed by a particular medical care provider. Consumer decisions based on such referrals can be time consuming and expensive if the referral does not meet the consumer's need or expectations. Both cost and quality of medical care can be significant factors in consumers' decisions to selecting a medical or health care provider. Therefore, a need exists for systems and processes for providing comparative health care information.

### SUMMARY OF THE INVENTION

Accordingly, systems and processes according to various aspects and embodiments according to the invention address at least some or all of these issues and combinations of them. They do so at least in part by providing comparative health care information.

Embodiments of the invention can provide methods and systems for providing health care and service information via a network. Specifically, embodiments of the invention can provide a consumer, such as a health care services consumer, with information to make decisions related to obtaining health care services. Embodiments of the invention can operate via a network and can receive health care information, such as costs for treatments or procedures performed by a particular health care practitioner or professional. Embodiments of the invention can store this information and process the information to provide statistical information related to the health care information, such as the average cost of treatments or procedures performed by a particular health care practitioner or professional, the average cost of a particular procedure in a geographic location, and the high and low costs of a particular procedure performed by a particular practitioner and/or as related to other practitioners or providers. Consumers can obtain or view the processed information via an Internet or web browser interface via the network. Via the interface, a consumer can drill down and analyze the information, including viewing additional detail and associated information for a particular practitioner or professional. The interface can provide a portal to additional information and services such as shopping for health care services, providing credentials for providers, providing quality and outcome-related information, listing appointment phone numbers for providers, generating a map from a consumer's home or location to the location of the provider, and providing medical and consumer information about a particular medical condition, treatment, or procedure.

One aspect of systems and methods according to various embodiments of the invention, focuses on a method for providing comparative health care information via a network. The method includes receiving insurance claim-related information from at least one data source. The method further includes based at least in part on the insurance claim-related information, determining cost information associated with at least one medical service provider including, but not limited, to a provider charge; eligible amount and amount actually paid including the actual, average, and standard deviations; and comparative cost or statistical information. In addition, the method includes based at least in part on the insurance claim-related information, determining provider information associated with at least one medical service provider. Furthermore, the method includes comparing cost information associated with at least one medical service provider with cost information associated with another medical service provider. Moreover, the method includes based at least in part on the comparison, generating an output providing selected cost information and provider information.

Another aspect of systems and methods according to various embodiments of the invention, focuses on a system for providing comparative health care information via a network. The system includes a comparative information application engine configured to receive insurance claim-related information from at least one data source. The comparative information application engine is further configured to determine cost information associated with at least one medical service provider based at least in part on the insurance claim-related information. In addition, the comparative information application engine is configured to determine provider information associated with at least one medical service provider based at least in part on the insurance claim-related information. Moreover, the comparative information application engine is configured to compare cost information associated with at least one medical service provider with cost information associated with another medical service provider. Furthermore, the comparative information application engine is configured to generate an output providing selected cost information and provider information based at least in part on the comparison.

Another aspect of systems and methods according to various embodiments of the invention, focuses on a method for providing health care information via a network. The method includes receiving insurance claim-related information from at least one disclosure source. The method also includes storing the insurance claim-related information in at least one data storage device. Furthermore, the method includes based at least in part on the insurance claim-related information, determining cost information associated with each of a plurality of insurance claims. In addition, the method includes based at least in part on the insurance claim-related information, determining provider information associated with each of the plurality of insurance claims. Further, the method includes receiving a request for comparative information from at least one client. Moreover, the method includes based at least in part on the request, generating an output providing comparative information associated with cost information associated with at least two medical service providers, and further providing corresponding provider information for the at least two medical service providers.

Aspects, features and advantages of various systems and processes according to various embodiments of the present invention can include:

(1) Providing systems and methods for providing comparative health care information;

(2) Providing systems and methods for providing comparative health care information via a network; and

(3) Providing systems and methods for providing health care and service information via a network.

Other aspects, features and advantages will become apparent with respect to the remainder of this document.

These example embodiments and aspects are mentioned not to limit or define the invention, but to provide examples of embodiments and aspects of the invention to aid understanding thereof. Example embodiments and aspects are discussed in the Detailed Description, and further description of the invention is provided there.

### BRIEF DESCRIPTION OF THE DRAWINGS

FIG. 1 illustrates an example flowchart of a method in accordance with an embodiment of the invention.

FIG. 2 illustrates an example system in accordance with an embodiment of the invention.

### DETAILED DESCRIPTION

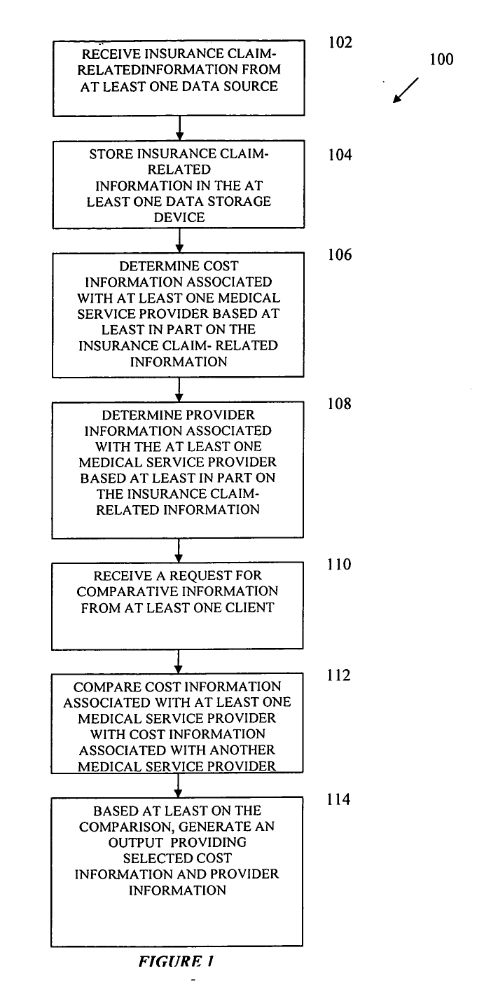

Referring now to the drawings in which like numerals indicate like elements throughout the several figures, FIG. 1 below illustrates a process flow 100 of information during providing comparative health care information via a network in accordance with an embodiment of the invention.

The process 100 can permit a user, such as a consumer of medical services, to obtain processed information to make a decision that may otherwise be made with possibly inaccurate or partial data. The process 100 can assist a user in filtering and obtaining cost and provider information by providing the user with the ability to obtain comparative and/or statistical data, such as data filtered using predefined thresholds and parameters. For example, comparative and/or statistical data can include, but is not limited to, actual provider-specific and/or location-specific data. Location-specific data can be, for instance, local, regional, state, or national-based data. Using such data, a user can make a medical care decision, and can select and purchase particular medical care if desired.

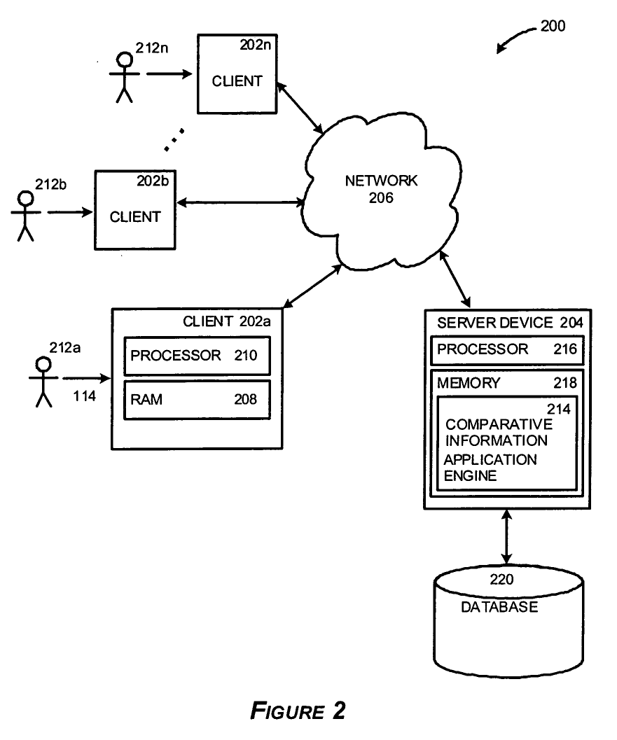

The process 100 begins at block 102. In block 102, insurance claim-related information is received. In the embodiment shown, the insurance claim-related information can be received by a comparative information engine, such as 214 in FIG. 2. Insurance claim-related information, also known as a “disclosure” or “claim-related information” can include, but is not limited to, a medical insurance claim, a precertification notice, prescription drug history, medical care provider name, medical care provider address, cost information, treatment provided, test provided, or any other information related to a medical or insurance claim for reimbursement or payment, or other data otherwise stored in an insurance claim-associated database or data storage device. Insurance claim-related information can be received at any time, such as in real time, a predefined basis, daily, or on a less or more frequent basis.

Block 102 is followed by block 104, in which the insurance claim-related information is stored in a database. In this embodiment, the insurance claim-related information is scrubbed, mapped, imported, and stored in a database, such as 220 in FIG. 2, or another data storage device.

In at least one embodiment, storing the insurance claim-related information in a database or data storage device is optional.

Block 104 is followed by block 106, in which cost information associated with at least one medical service provider is determined from at least a portion of the insurance claim-related information. In this embodiment, the cost information can be determined by a comparative information application program such as 214 in FIG. 2. Cost information can include, but is not limited, a cost for an item, a cost for a treatment, a cost for a test, a cost for a procedure, a cost for a visit, a provider charge, or an eligible amount and amount actually paid. Costs for an item or a procedure can also include a combination of costs from multiple items or procedures.

In one embodiment, cost information can be determined by filtering insurance claim-related information to determine at least one cost paid for a service associated with at least one medical service provider.

Block 106 is followed by block 108, in which provider information associated with at least one medical service provider is determined from at least a portion of the insurance claim-related information. In this embodiment, the insurance claim-related information can be processed by an automated disclosure processing application program such as 214 in FIG. 2. Provider information can include, but is not limited to, a name, an address, a phone number, education level, quality of care information, and outcome-associated data.

In one embodiment, provider information can be determined by filtering insurance claim-related information to determine information associated with at least one medical service provider

Block 108 is followed by block 110, a request for comparative information is received. In the embodiment shown, a user operating a client device, such as 202a in FIG. 2, can initiate a request for comparative and/or statistical information from the client device by transmitting a signal from the client device to a comparative information application engine, such as 214 in FIG. 2.

In at least one embodiment, receiving a request for comparative and/or statistical information is optional.

In one embodiment, receiving a request for comparative information can include receiving a request for comparative and/or statistical information from at least one client device, such as 202a in FIG. 2. For example, receiving a request for comparative information can include receiving an instruction to provide comparative-type and/or statistical information associated with at least one predefined parameter, such as cost. Based at least in part on the predefined parameter, comparative-type and/or statistical information can be determined, such as one cost from a first medical service provider and another cost from a second medical service provider.

Examples of predefined parameters can include, but are not limited to, an area, a geographic area, an item, a medical specialty, a medical procedure, a treatment, a service, a date of service, or a price or a cost. Other methods can utilize other predefined parameters in accordance with other embodiments of the invention.

Block 110 is followed by block 112, in which cost information associated with at least one medical service provider is compared with cost information associated with another medical service provider. In the embodiment shown, a comparative information application engine, such as 214 in FIG. 2, can compare cost information associated with a first medical service provider and cost information associated with another medical service provider. Cost information associated with any number of medical service providers can be compared.

In one embodiment, comparative and/or statistical information can include, but is not limited to, low cost, mean cost, median cost, high cost, and statistical information associated with at least one cost.

Block 112 is followed by block 114, in which based at least on the comparison, an output is generated providing selected provider information and cost information. In the embodiment shown, a comparative information application engine, such as 214 in FIG. 2, can facilitate the display of an output via a client device, such as 202a in FIG. 2, or associated display device by transmitting a suitable signal to the client device 202a or associated display device.

In one embodiment, generating an output includes providing a graphical user interface capable of displaying selected cost information and provider information.

The process 100 ends at block 114.

In one aspect of an embodiment of the invention, a web based/browser based window or other graphical user interface associated with an application program can permit real time viewing and manipulation of data by a user. For example, such a web based/browser based window or other graphical user interface can be associated with comparative information application engine, such as 214 in FIG. 2, and the window can be displayed via a client device, such as 202a in FIG. 2, for viewing by a user, such as 212a in FIG. 2. Data, such as statistical information and/or comparative data, can be viewed, manipulated and/or selected by the user 212a via the window or other graphical user interface.

In another aspect of the invention, various webpages or other user interfaces can be implemented or otherwise facilitated by embodiments of the invention. For example, such webpages or other user interfaces can be associated with comparative information application engine, such as 214 in FIG. 2, and the webpages or other user interfaces can be displayed via a client device, such as 202a in FIG. 2, for viewing by a user, such as 212a in FIG. 2. Data, such as statistical information and/or comparative data, can be viewed, manipulated and/or selected by the user 212a via the webpages or other user interfaces.

Some or all of the processes and aspects described above can be incorporated into one or more application programs, such as an application program known as the iCOST™ application suite to be distributed by Innovative Health Strategies, Inc. of Augusta, Ga. One embodiment of an application program in accordance with the invention is described below.

An application program in accordance with an embodiment of the invention, such as the iCOST™ application suite, can provide information in the field of health care. By accumulating and presenting information, the iCOST™ application suite can provide a platform for consumers to make decisions that they otherwise make with possibly inaccurate or partial data. The iCOST™ application suite is directed towards assisting consumers with comparative cost information and provider information. Such information can permit consumers to acquire data needed to address their own or their family's medical needs and to make a financial and quality of care-driven decision.

FIG. 2 below is an illustration of example system components for a system in accordance with an embodiment of the invention. The system 200 shown in FIG. 2 comprises multiple client devices 202a-n in communication with a server device 204 over a network 206. The network 206 shown can comprise the Internet, an automated or electronic insurance data network, any other suitable network, or any combination of such networks or other suitable network components. In other embodiments, other networks or network components, wired and wireless, such as an intranet, local area network, wide area network, or broadcast network may be used. Moreover, methods according to the embodiments of the invention, such as the method 100 in FIG. 1, can be implemented with the system 200 shown, and may also operate within a single client and/or server device.

Each client device 202a-n shown in FIG. 2 preferably comprises a computer-readable medium. The computer-readable medium shown can comprise a random access memory (RAM) 208 coupled to a processor 210. The processor 210 can execute computer-executable program instructions stored in the memory 208. Such processors may comprise a microprocessor, an Application-Specific Integrated Circuit (ASIC), a state machine, or other processor. Such processors comprise, or may be in communication with, media, for example computer-readable media, which stores instructions that, when executed by the processor, cause the processor to perform the steps described herein.

Embodiments of computer-readable media may comprise an electronic, optical, magnetic, or other storage or transmission device capable of providing a processor, such as the processor 210 of client 202a, with computer-readable instructions. Other examples of suitable media may comprise a floppy disk, Compact Disk Read Only Memory (CD-ROM), magnetic disk, memory chip, Read Only Memory (ROM), Random Access Memory (RAM), an ASIC, a configured processor, all optical media, all magnetic tape or other magnetic media, or any other suitable medium from which a computer processor can read instructions or on which instructions, code, or other data may be stored. Also, various other forms of computer-readable media may transmit or carry instructions to a computer, including a router, private or public network, or other transmission device or channel, both wired and wireless. The instructions may comprise code from any suitable computer-programming language, including but not limited to, for example, C, C++, C#, Visual Basic, Java, Python, Perl, and JavaScript.

Client devices 202a-n may also comprise a number of external or internal devices such as a magnetic or smart card reader, biometric data collection devices, mouse, a CD-ROM, a keyboard, a display, or other input or output devices. Examples of client devices 202a-n are card terminals, personal computers, media center computers, televisions, television set-top boxes, digital assistants, personal digital assistants, cellular phones, mobile phones, smart phones, pagers, digital tablets, laptop computers, Internet appliances, and other processor-based devices. In general, a client device 202a-n may be any type of processor-based platform that may be connected to a network 206 and that interacts with one or more application programs. Client devices 202a-n may operate on any operating system, such as Microsoft® Windows®, Macintosh, Unix, or Linux, capable of supporting one or more client application programs. For example, the client device 202a shown comprises a personal computer executing client application programs, also known as client applications. The client applications can be contained in memory 208 and can comprise, for example, an Internet browser application, and any other application or computer program capable of being executed by a client device.

Each of the client devices 202a-n can be associated with a user or consumer, an insurance company, a hospital, a doctor, a carrier, a managing general underwriter (MGU), a third party administrator (TPA), or a plan sponsor, shown as users 212a-n. Through the client devices 202a-n, users such as 212a-n can communicate over the network 206 with each other and with other systems and devices coupled to the network 206. As shown in FIG. 2, a server device 204 is also coupled to the network 206. For example in the embodiment shown in FIG. 2, a user such as 212a can operate a respective client 202a to interact with the server device 204 and formulate a request for processing an insurance disclosure. The client 202a can send a signal corresponding to the request via the network 206 to the server 204.

The server device 204 shown in FIG. 2 comprises a server executing at least one comparative information application program, also known as the comparative information application engine 214 or comparative information program. Similar to the client devices 202a-n, the server device 204 shown in FIG. 2 comprises a processor 216 coupled to a computer-readable memory 218. Server device 204, depicted in FIG. 2 as a single computer system, may be implemented as a network of computer processors. Examples of a server device are servers, mainframe computers, networked computers, a processor-based device, and similar types of systems and devices. Client processors 210 and the server processor 216 can be any of a number of well known computer processors, such as processors from Intel Corporation of Santa Clara, Calif. and Motorola Corporation of Schaumburg, Ill.

Memory 218 on the server device 204 can contain the comparative information application engine 214. The comparative information application engine 214 can comprise a software or hardware application that is configured to provide comparative information based at least on provider information or cost information. In one embodiment, a comparative information application engine 214 can be the iCOST™ software program to be distributed by Innovative Health Strategies, Inc., of Augusta, Ga. In response to a request for statistical information from a user 212a operating a client 202a, the comparative information application 214 shown in FIG. 2 can generate an output based in part on at least provider information or cost information.

In one embodiment, a comparative information application engine such as 214 can provide a comparison of costs for a particular medical service provided by medical service providers, such a hip replacement performed by particular surgeons or hospitals. For example, a comparative information application engine can provide a variety of statistical information associated with the costs for a particular medical service provided by medical service providers. In addition, the comparative information application engine such as 214 can provide provider information for each of the medical service providers associated with the comparison of costs. For example, a comparative information application engine can provide suitable contact information for a user to call, communicate, or otherwise facilitate contact with a particular medical service provider. In one instance, a comparative information application engine can provide a telephone number, and if VOIP (voice over Internet Protocol)—equipped, the comparative information application engine can facilitate VOIP communications via the telephone number. In another instance, a comparative information application engine can provide a map from the user's home or location to the provider's location.

The server device 204 can also communicate with at least one database 220, such as a medical insurance claim-related information database, or other data storage device to retrieve and/or store information associated with cost information and provider information. The database 220 can comprise one or more data storage devices with insurance claim-related information, or any other information which can be used to determine cost information and provider information.

Although the processes described herein are described in relation to the client and server or servers, a client may perform any or all of the processes described as being performed by a server. Similarly, a server or servers may perform any or all of the processes described herein as being performed by a client, although the invention is not limited to client/server architecture but can run on any desired topology or architecture as deemed fit for the purposes, whether existing as of the time of the writing of this document or thereafter.

Embodiments of the invention can comprise systems having different architecture than that which is shown in FIG. 2. For example, in some systems according to embodiments of the invention, server device 204 may comprise a single physical or logical server. The system 200 shown in FIG. 2 is merely an example, and is used as an environment to help explain the example processes and methods shown in FIG. 1.

As shown in FIG. 2, an example automated disclosure processing application engine 214 can include one or more functional components to accomplish some or all of the following functionality: determine cost information based at least in part on insurance claim-related information, determine provider information based at least in part on insurance claim-related information, provide comparative and/or statistical information based at least in part on insurance claim-related information, provide comparative information based at least in part on either the cost information or the provider information, and generate an output providing selected cost information and/or provider information. Other functions, components, modules, or sub-components for a comparative information application engine 214 can exist in accordance with other embodiments of the invention.

In the embodiment shown in FIG. 2, the comparative information application engine 214 can provide a user interface for use of the application engine 214 by users 212a-n via the network 206. The user interface can provide users 212a-n with on-line accessibility to details of cost information or provider information, and on-line functionality of the comparative information application engine 214. The comparative information application engine 214 can also provide a user interface for a user 212a-n to interact with the comparative information application engine 214.

In one embodiment, a comparative information application engine 214 can include a cost module adapted to determine cost information based at least in part on insurance claim-related information. The cost module can receive, filter, and process insurance claim-related data associated with customers for information associated with costs of various health care treatments, procedures, visits, or services. Data can be stored in and/or accessed from one or more associated databases, such as database 226, data storage device, a comparative information or health care information database, or any other suitable database or data storage device.

In yet another embodiment, a comparative information application engine 214 can include a provider module adapted to determine provider information based at least in part on insurance claim-related information. The provider module can receive, filter, and process insurance claim-related data associated with customers for information associated with providers of various health care treatments, procedures, visits, or services. Data can be stored in and/or accessed from one or more associated databases, such as database 226, a comparative information or health care information database, or any other suitable database or data storage device.

In yet another embodiment, a comparative information application engine 214 can determine comparative and/or statistical information based at least in part on either cost information or provider information. For example, low, mean, median, and high costs for a particular medical treatment can be determined and output for a user to view. Statistical information can include, but is not limited, a range, a maximum, a minimum, a median, a mean, or any other statistic of cost. A user can view provider information associated with some or all of the cost information, comparative information, or statistical information displayed.

In another embodiment, a comparative information application engine 214 can provide functionality to permit a user to filter insurance claim-related information according to a predefined threshold or parameter. Using such thresholds or parameters, a comparative information application engine 214 can determine cost information and/or provider information for display to the user. For example, a user can filter data based on any of the following: an area, a geographic area, an item, a medical specialty, a medical procedure, a treatment, a service, a date of service, or a price or a cost. Other thresholds or parameters can be defined and can be used to filter information in accordance with other embodiments of the invention.

In one embodiment, a comparative information application engine 214 can provide e-commerce functionality for a user to purchase, schedule, or otherwise contact a medical care provider offering a desired treatment, procedure, visit, or service. Other functionality that can be provided by embodiments of the invention can include, but is not limited to, providing credentials for providers, providing quality and outcome-related information, listing appointment phone numbers for providers, generating a map from a consumer's home or location to the location of the provider, and providing medical and consumer information about a particular medical condition, treatment, or procedure.

In another embodiment, a comparative information application engine 214 can include a report module adapted to facilitate transmission of a summary report to a customer or user, such as a comparative report of prices for a particular treatment offered by various medical care providers.

Collectively, the components of the comparative information application engine 214 can process insurance claim-related information and provide comparative information such as statistical information based at least in part on either cost information or provider information. Users 212a-n can focus more on comparing costs and providers of medical care treatments, procedures, visits, or services.

Example methods that can be performed by a comparative information processing engine, in accordance with embodiments of the invention, are illustrated in FIG. 1. The methods shown in FIG. 1 can be implemented in conjunction with the example system 200 shown in FIG. 2. This method and other methods can be performed or otherwise implemented on other system embodiments in accordance with other embodiments of the invention.

While the above description contains many specifics, these specifics should not be construed as limitations on the scope of the invention, but merely as exemplifications of the disclosed embodiments. Those skilled in the art will envision any other possible variations that are within the scope of the invention.

The invention claimed is:

1. A method for providing comparative health care information via a network comprising:
receiving insurance claim-related information from at least one data source;
based at least in part on the insurance claim-related information, determining cost information associated with at least one medical service provider;
based at least in part on the insurance claim-related information, determining provider information associated with at least one medical service provider;
comparing cost information associated with at least one medical service provider with cost information associated with another medical service provider; and
based at least in part on the comparison, generating an output providing selected cost information and provider information.

2. The method of claim 1, wherein receiving insurance claim-related information from at least one data source, comprises:
receiving insurance claim-related information from at least one disclosure source; and
storing the insurance claim-related information in at least one data storage device.

3. The method of claim 1, wherein the at least one data source includes data comprising at least one of the following: medical insurance claim data, a precertification notice, prescription drug history, a medical care provider name, a medical care provider address, provider information, cost information, treatment provided, test provided, information associated with at least one medical insurance claim, or information associated with at least one insurance claim for reimbursement or payment.

4. The method of claim 1, wherein determining cost information associated with at least one medical service provider comprises:
filtering the insurance claim-related information to determine at least one cost paid for a service associated with the at least one medical service provider.

5. The method of claim 1, wherein cost information comprises at least one of the following: a cost for an item, a cost for a medical treatment, a cost for a medical test, a cost for a medical procedure, a cost for a medical visit, a provider charge, or an eligible amount and amount actually paid.

6. The method of claim 1, wherein determining provider information associated with at least one medical service provider comprises:
filtering the insurance claim-related information to determine information associated with the at least one medical service provider.

7. The method of claim 1, wherein provider information comprises at least one of the following: a name, an address, a phone number, and educational degree, an experience level, quality of care information, or outcome-associated data.

8. The method of claim 1, further comprising:
receiving a request for comparative information from at least one client.

9. The method of claim 8, wherein receiving a request for comparative information from at least one client comprises:
receiving an instruction to provide comparative information associated with at least one predefined parameter; and
based at least in part on the at least one predefined parameter, determining the comparative information, wherein the comparative information includes at least one cost from one medical service provider and another cost from a second medical service provider.

10. The method of claim 9, wherein the predefined parameter comprises at least one of the following: a geographic area, a medical specialty, an item, a medical procedure, a medical treatment, a medical service, a date of service, a price, or a cost.

11. The method of claim 1, wherein generating an output providing selected cost information and provider information comprises providing a graphical user interface capable of displaying selected cost information and provider information.

12. The method of claim 8, wherein comparative information comprises at least one of the following: low cost, mean cost, median cost, high cost, or statistical information associated with at least one cost.

13. A system for providing comparative health care information via a network comprising:
a comparative information application engine configured to receive insurance claim-related information from at least one data source;
based at least in part on the insurance claim-related information, determine cost information associated with at least one medical service provider;
based at least in part on the insurance claim-related information, determine provider information associated with at least one medical service provider;
compare cost information associated with at least one medical service provider with cost information associated with another medical service provider; and
based at least in part on the comparison, generate an output providing selected cost information and provider information.

14. The system of claim 13, further comprising:
a commerce module configured to facilitate user selection of a particular medical service provider; and
facilitate transmission of a communication from a user to the particular medical service provider.

15. The system of claim 14, wherein the communication comprises at least one of the following: an appointment, a purchase, an order, a request for an appointment, or a request for a medical service.

16. The system of claim 14, further comprising:
a report module configured to:
prepare a summary report, wherein the summary report comprises comparative information for at least one medical service offered by a plurality of medical service providers; and
transmit the summary report to a client.

17. A method for providing health care information via a network, comprising:
receiving insurance claim-related information from at least one disclosure source;
storing the insurance claim-related information in at least one data storage device;
based at least in part on the insurance claim-related information, determining cost information associated with at least a portion of a plurality of insurance claims;
based at least in part on the insurance claim-related information, determining provider information associated with at least a portion of the plurality of insurance claims;
receiving a request for comparative information from at least one client; and
based at least in part on the request, generating an output providing comparative information associated with cost information associated with at least two medical service providers, and further providing corresponding provider information for the at least two medical service providers.

18. The method of claim 17, wherein determining cost information associated with at least a portion of a plurality of insurance claims comprises:
filtering the insurance claim-related information to determine at least one cost paid for a service associated with at least a portion of the plurality of medical service providers.

19. The method of claim 17, wherein determining provider information associated with at least a portion of the plurality of insurance claims comprises:
filtering the insurance claim-related information to determine information associated with at least a portion of the plurality of medical service providers.

20. The method of claim 17, wherein receiving a request for comparative information from at least one client comprises:
comparing cost information associated with at least one medical service provider with cost information associated with another medical service provider.
